(19) United States
(12) Patent Application Publication
(10) Pub. No.: US 2023/0139729 A1
(43) Pub. Date: May 4, 2023

(54) METHOD AND APPARATUS TO DYNAMICALLY SHARE NON-VOLATILE CACHE IN TIERED STORAGE

(71) Applicant: Intel Corporation, Santa Clara, CA (US)

(72) Inventors: Mariusz BARCZAK, Gdansk (PL); Wojciech MALIKOWSKI, Gdansk (PL); Mateusz KOZLOWSKI, Gdansk (PL); Lukasz LASEK, Skarzysko Kamienna (PL); Artur PASZKIEWICZ, Gdansk (PL); Krzysztof SMOLINSKI, Elblag (PL)

(21) Appl. No.: 18/089,717

(22) Filed: Dec. 28, 2022

(51) Int. Cl. G06F 12/0802

(52) U.S. Cl. CPC G06F 12/0802; G06F 2212/1016

(57) ABSTRACT

To increase the availability of a non-volatile cache for use by workloads, the non-volatile cache is dynamically assigned to workloads. The non-volatile cache assigned to a workload can be reduced or increased on demand. A cache space manager ensures that the physical non-volatile cache is available to be assigned prior to assigning. A workload analyzer recognizes a sequential or random workload and requests to reduce the cache space assigned for the sequential or random workload. The workload analyzer recognizes a locality workload, waits until cache space is available in the non-volatile cache and requests an increase of cache space for the locality workload.

### FIELD OF THE INVENTION

This disclosure relates to tiered storage and in particular to dynamically share non-volatile cache space in tiered storage.

### BACKGROUND OF THE INVENTION

Virtualization allows system software called a virtual machine monitor (VMM), also known as a hypervisor, to create multiple isolated execution environments called virtual machines (VMs) in which operating systems (OSs) and applications can run. Virtualization is extensively used in enterprise and cloud data centers as a mechanism to consolidate multiple workloads onto a single physical machine while still keeping the workloads isolated from each other. Applications running in the virtual machines can share a physical storage device in the physical machine.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system 110 for executing one or more workloads;

FIG. 2 is a simplified block diagram of at least one embodiment of a compute node in the system shown in FIG. 1;

FIG. 3 is a simplified block diagram of at least one embodiment of a storage node usable in the system shown in FIG. 1;

FIG. 4 is a block diagram of system that includes the orchestrator server, the compute node and the storage node shown in FIG. 1 to dynamically assign a portion of non-volatile cache in the storage node for use by workloads in the compute node;

FIG. 5 is a block diagram of the system shown in FIG. 4 with virtual machine 0 and flash translation layer 0 shown in FIG. 4 to dynamically assign non-volatile cache in the storage node for use by workloads in the compute node;

FIG. 6 is a flowgraph illustrating a method to increase the number of free chunks in the non-volatile cache; and

FIG. 7 is a flowgraph illustrating a method to decrease the number of free chunks in the non-volatile cache.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF THE INVENTION

The physical storage can be a tiered storage that includes a first storage device and a second storage device. The first storage device is used as a non-volatile cache to cache data for a workload to be written later to the second storage device. A portion of the capacity of the first storage device that is statically assigned to cache data for a workload cannot be assigned to other workloads. Some types of workloads do not require a lot of cache. For example, there is no performance difference using a large cache or small cache for a sequential workload or a uniform random workload.

To increase the availability of non-volatile cache for use by workloads, the non-volatile cache is dynamically assigned to workloads. The non-volatile cache assigned to a workload can be reduced or increased on demand. A cache space manager ensures that the physical non-volatile cache is available to be assigned prior to assigning. A workload analyzer recognizes a workload type to be a sequential workload or a random workload and requests a reduction in the cache space assigned for the sequential workload or the random workload. A sequential workload accesses data in storage in a predetermined ordered sequence. A random workload is a workload in which an access pattern to storage is determined by random uniform distribution.

The workload analyzer recognizes a workload type to be a locality workload, waits until cache space is available and requests an increase of cache space assigned for the locality workload. A locality workload is a workload in which an Input Output (IO) access pattern is based on a cache hit ratio (for example, a Zipfian distribution).

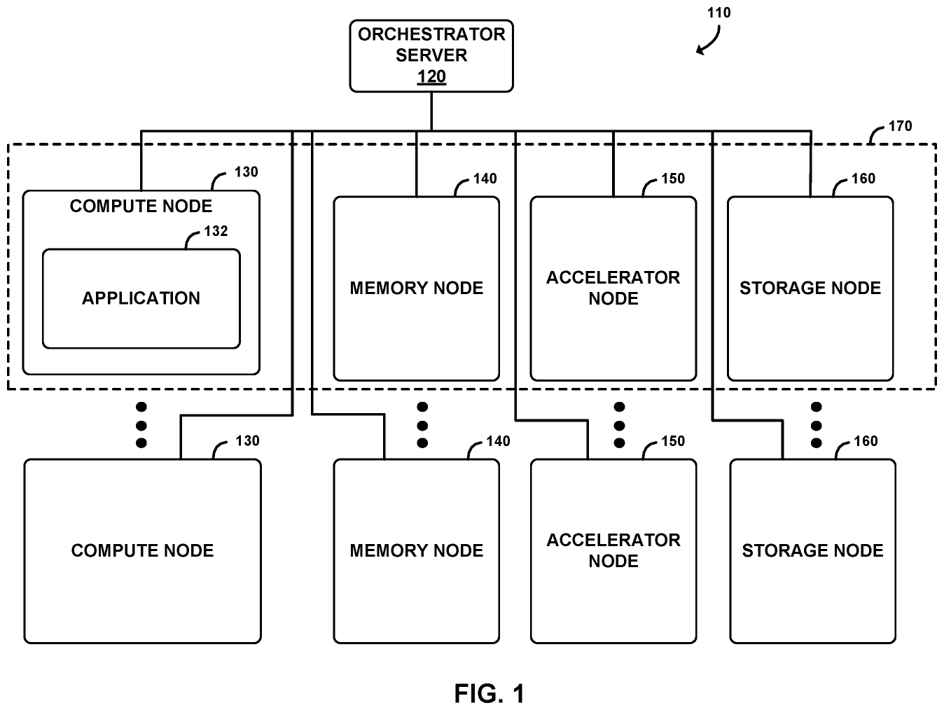

FIG. 1 is a block diagram of a system 110 for executing one or more workloads. Examples of workloads include applications and microservices. A data center can be embodied as a single system 110 or can include multiple systems. The system 110 includes multiple nodes, some of which may be equipped with one or more types of resources (e.g., memory devices, data storage devices, accelerator devices, general purpose processors, Graphics Processing Units (GPUs), x Processing Units (xPUs), Central Processing Units (CPUs), field programmable gate arrays (FPGAs), or application-specific integrated circuits (ASICs)).

In the illustrative embodiment, the system 110 includes an orchestrator server 120, which may be embodied as a managed node comprising a compute device (for example, a processor on a compute node) executing management software (for example, a cloud operating environment, such as OpenStack) that is communicatively coupled to multiple nodes including a large number of compute nodes 130, memory nodes 140, accelerator nodes 150, and storage nodes 160. A memory node is configured to provide other nodes with access to a pool of memory. One or more of the nodes 130, 140, 150, 160 may be grouped into a managed node 170, such as by the orchestrator server 120, to collectively perform a workload (for example, an application 132 executed in a virtual machine or in a container). While orchestrator server 120 is shown as a single entity, alternatively or additionally, its functionality can be distributed across multiple instances and physical locations.

The managed node 170 may be embodied as an assembly of physical resources, such as processors, memory resources, accelerator circuits, or data storage, from the same or different nodes. Further, the managed node 170 may be established, defined, or “spun up” by the orchestrator server 120 at the time a workload is to be assigned to the managed node 170, and may exist regardless of whether a workload is presently assigned to the managed node 170. In the illustrative embodiment, the orchestrator server 120 may selectively allocate and/or deallocate physical resources from the nodes and/or add or remove one or more nodes from the managed node 170 as a function of quality of service (QoS) targets (for example, a target throughput, a target latency, a target number of instructions per second, etc.) associated with a service level agreement or class of service (COS or CLOS) for the workload (for example, the application 132). In doing so, the orchestrator server 120 may receive telemetry data indicative of performance conditions (for example, throughput, latency, instructions per second, etc.) in each node of the managed node 170 and compare the telemetry data to the quality-of-service targets to determine whether the quality of service targets are being satisfied. The orchestrator server 120 may additionally determine whether one or more physical resources may be deallocated from the managed node 170 while still satisfying the QoS targets, thereby freeing up those physical resources for use in another managed node (for example, to execute a different workload). Alternatively, if the QoS targets are not presently satisfied, the orchestrator server 120 may determine to dynamically allocate additional physical resources to assist in the execution of the workload (for example, the application 132) while the workload is executing. Similarly, the orchestrator server 120 may determine to dynamically deallocate physical resources from a managed node 170 if the orchestrator server 120 determines that deallocating the physical resource would result in QoS targets still being met.

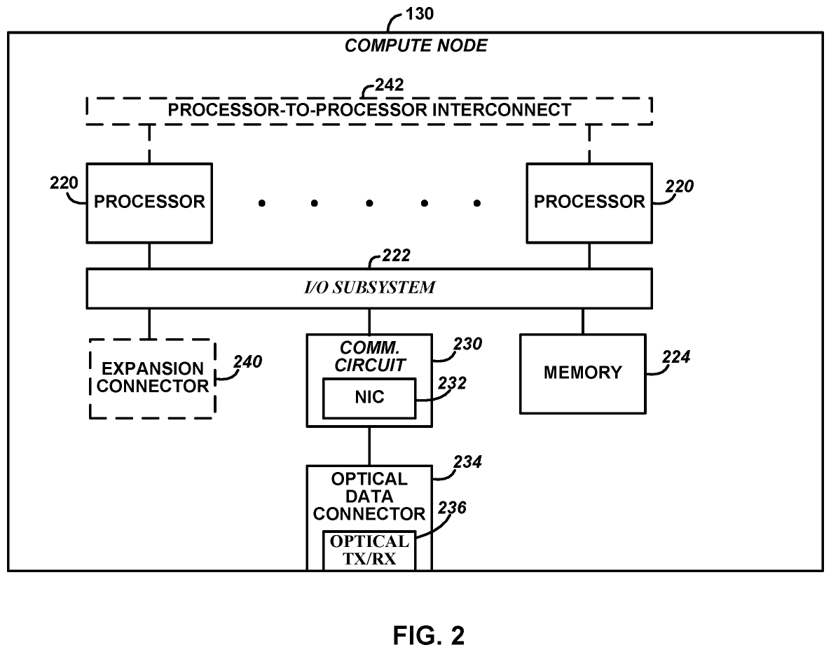

FIG. 2 is a simplified block diagram of at least one embodiment of a compute node 130 in the system shown in FIG. 1. The compute node 130 can be configured to perform compute tasks. As discussed above, the compute node 130 may rely on other nodes, such as acceleration nodes 150 and/or storage nodes 160, to perform compute tasks. In the illustrative compute node 130, physical resources are embodied as processors 220. Although only two processors 220 are shown in FIG. 2, it should be appreciated that the compute node 130 may include additional processors 220 in other embodiments. Illustratively, the processors 220 are embodied as high-performance processors 220 and may be configured to operate at a relatively high power rating.

In some embodiments, the compute node 130 may also include a processor-to-processor interconnect 242. Processor-to-processor interconnect 242 may be embodied as any type of communication interconnect capable of facilitating processor-to-processor interconnect 242 communications. In the illustrative embodiment, the processor-to-processor interconnect 242 is embodied as a high-speed point-to-point interconnect. For example, the processor-to-processor interconnect 242 may be embodied as a QuickPath Interconnect (QPI), an UltraPath Interconnect (UPI), or other high-speed point-to-point interconnect utilized for processor-to-processor communications (for example, Peripheral Component Interconnect express(PCIe) or Compute Express Link™ (CXL™)).

The compute node 130 also includes a communication circuit 230. The illustrative communication circuit 230 includes a network interface controller (NIC) 232, which may also be referred to as a host fabric interface (HFI). The NIC 232 may be embodied as, or otherwise include, any type of integrated circuit, discrete circuits, controller chips, chipsets, add-in-boards, daughtercards, network interface cards, or other devices that may be used by the compute node 130 to connect with another compute device (for example, with other nodes). In some embodiments, the NIC 232 may be embodied as part of a system-on-a-chip (SoC) that includes one or more processors, or included on a multichip package that also contains one or more processors. In some embodiments, the NIC 232 may include a local processor (not shown) and/or a local memory (not shown) that are both local to the NIC 232. In such embodiments, the local processor of the NIC 232 may be capable of performing one or more of the functions of the processors 220. Additionally, or alternatively, in such embodiments, the local memory of the NIC 232 may be integrated into one or more components of the compute node 130 at the board level, socket level, chip level, and/or other levels. In some examples, a network interface includes a network interface controller or a network interface card. In some examples, a network interface can include one or more of a network interface controller (NIC) 232, a host fabric interface (HFI), a host bus adapter (HBA), network interface connected to a bus or connection (for example, PCIe or CXL). In some examples, a network interface can be part of a switch or a system-on-chip (SoC).

Some examples of a NIC 232 are part of an Infrastructure Processing Unit (IPU) or Data Processing Unit (DPU) or utilized by an IPU or DPU. An IPU or DPU can include a network interface, memory devices, and one or more programmable or fixed function processors (for example, CPU or XPU) to perform offload of operations that could have been performed by a host CPU or XPU or remote CPU or XPU. In some examples, the IPU or DPU can perform virtual switch operations, manage storage transactions (for example, compression, cryptography, virtualization), and manage operations performed on other IPUs, DPUs, servers, or devices.

The communication circuit 230 is communicatively coupled to an optical data connector 234. The optical data connector 234 is configured to mate with a corresponding optical data connector of a rack when the compute node 130 is mounted in the rack. Illustratively, the optical data connector 234 includes a plurality of optical fibers which lead from a mating surface of the optical data connector 234 to an optical transceiver 236. The optical transceiver 236 is configured to convert incoming optical signals from the rack-side optical data connector to electrical signals and to convert electrical signals to outgoing optical signals to the rack-side optical data connector. Although shown as forming part of the optical data connector 234 in the illustrative embodiment, the optical transceiver 236 may form a portion of the communication circuit 230 in other embodiments.

The I/O subsystem 222 may be embodied as circuitry and/or components to facilitate Input/Output operations with memory 224 and communications circuit 230. In some embodiments, the compute node 130 may also include an expansion connector 240. In such embodiments, the expansion connector 240 is configured to mate with a corresponding connector of an expansion circuit board substrate to provide additional physical resources to the compute node 130. The additional physical resources may be used, for example, by the processors 220 during operation of the compute node 130. The expansion circuit board substrate may include various electrical components mounted thereto. The particular electrical components mounted to the expansion circuit board substrate may depend on the intended functionality of the expansion circuit board substrate. For example, the expansion circuit board substrate may provide additional compute resources, memory resources, and/or storage resources. As such, the additional physical resources of the expansion circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits. Note that reference to GPU or CPU herein can in addition or alternatively refer to an XPU or xPU. An xPU can include one or more of: a GPU, ASIC, FPGA, or accelerator device.

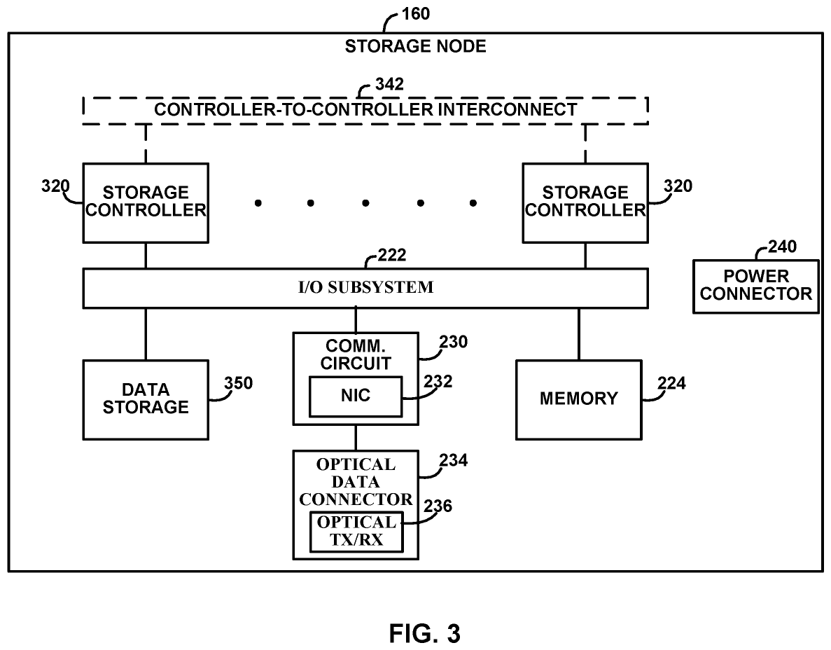

FIG. 3 is a simplified block diagram of at least one embodiment of a storage node 160 usable in the system shown in FIG. 1.

The storage node 160 is configured in some embodiments to store data in a data storage 350 local to the storage node 160. For example, during operation, a compute node 130 or an accelerator node 150 may store and retrieve data from the data storage 350 of the storage node 160.

In the illustrative storage node 160, physical resources are embodied as storage controllers 320. Although only two storage controllers 320 are shown in FIG. 3, it should be appreciated that the storage node 160 may include additional storage controllers 320 in other embodiments. The storage controllers 320 may be embodied as any type of processor, controller, or control circuit capable of controlling the storage and retrieval of data into/from the data storage 350 based on requests received via the communication circuit 230 or other components. In the illustrative embodiment, the storage controllers 320 are embodied as relatively low-power processors or controllers.

In some embodiments, the storage node 160 may also include a controller-to-controller interconnect 342. The controller-to-controller interconnect 342 may be embodied as any type of communication interconnect capable of facilitating controller-to-controller communications. In the illustrative embodiment, the controller-to-controller interconnect 342 is embodied as a high-speed point-to-point interconnect (e.g., faster than the I/O subsystem 222). For example, the controller-to-controller interconnect 342 may be embodied as a QuickPath Interconnect (QPI), an UltraPath Interconnect (UPI), or other high-speed point-to-point interconnect utilized for controller-to-controller communications.

The I/O subsystem 222 may be embodied as circuitry and/or components to facilitate Input/Output operations with memory 224 and communications circuit 230.

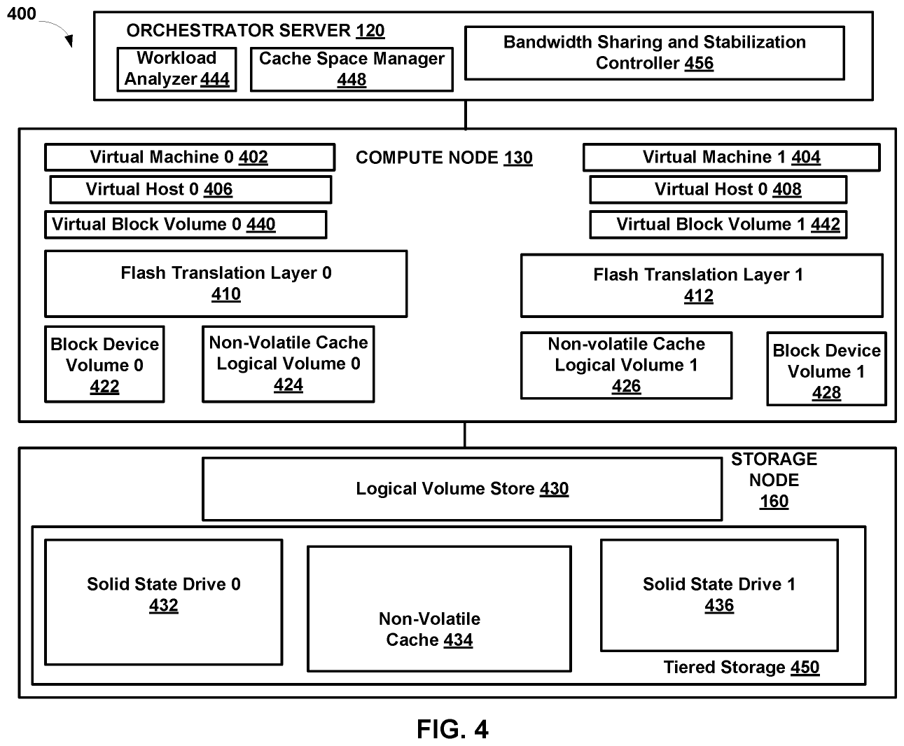

FIG. 4 is a block diagram of system 400 that includes the orchestrator server 120, compute node 130 and storage node 160 shown in FIG. 1 to dynamically assign non-volatile cache 434 in the storage node 160 for use by workloads in the compute node 130.

The orchestrator server 120 includes a workload analyzer 444, a cache space manager 448 and a bandwidth sharing and stabilization controller 456.

The storage node 160 includes logical volume store 430 and tiered storage 450. Tiered storage 450 includes solid state drive 0 432, solid state drive 1 436 and a non-volatile cache 434. The non-volatile cache 434 can be a byte-addressable, write-in-place non-volatile memory (for example, 3 Dimensional (3D) crosspoint memory), a solid state drive with Single-Level Cell (“SLC”) NAND or a solid state drive with byte-addressable, write-in-place non-volatile memory.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Tri-Level Cell (“TLC”), Quad-Level Cell (“QLC”), Penta-Level Cell (PLC) or some other NAND). A NVM device can also include a byte-addressable, write-in-place three dimensional Crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

The compute node 130 includes virtual machine 0 402 and virtual machine 1 404. Each virtual machine 402, 404 has a respective virtual host 406, 408, virtual block volume 440, 442, flash translation layer 410, 412, block device volume 422, 428 and non-volatile cache logical volume 424, 426 to provide access to the tiered storage 450. In an embodiment, the respective flash translation layer 410, 412, block device volume 422, 428, and non-volatile cache logical volume 424, 426 are part of Cloud Storage Acceleration Layer (CSAL) software.

Flash translation layer 410, 412 represents a virtual block device that is exposed to the virtual machine 402, 404 using a virtualization protocol (for example, using virtual host 406, 408 and virtual block device volume 440, 442). Flash translation layer 0 410 and flash translation layer 1 412 map logical addresses from the respective virtual machines 402, 404 to physical addresses in the non-volatile cache 434. Block device volume 0 422 is a block access abstraction/Application Programming Interface (API) to access a physical storage device (for example, solid state drive 0 432 in tiered storage 450). Block device volume 1 428 is a block access abstraction/Application Programming Interface (API) to access a physical storage device (for example, solid state drive 1 436 in tiered storage 450).

Access to the tiered storage 450 for virtual machine 0 402 is provided by virtual host 0 406, virtual block volume 0 440 and flash translation layer 0 410. Access to the tiered storage 450 for virtual machine 1 404 is provided by virtual host 1 408, virtual block volume 1 442 and flash translation layer 1 412.

The non-volatile cache 434 in tiered storage 450 is shared by flash translation layer 0 410 and flash translation layer 1 412. The logical volume store 430 in storage node 160 allocates physical memory blocks in the non-volatile cache 434 for flash translation layer 0 410 and flash translation layer 1 412. For example, a non-volatile cache 434 having 100 GigaBytes (GiB) physical memory can be split onto 100 clusters, with each cluster having 1 GiB and each cluster mapped to 1 GiB of contiguous physical blocks in the non-volatile cache 434.

A non-volatile cache logical volume 424, 428 is created in thin provisioning mode for each virtual machine 402, 404. With thin provisioning, the size of the non-volatile cache logical volume 424, 428 is greater than the physical memory for the non-volatile cache 434. For example, the size of the non-volatile cache logical volume 424, 428 can be 2 Tera Bytes (TB) and for a 1 TB physical space for the non-volatile cache 434.

Non-volatile cache logical volume 0 424 is created for virtual machine 0 402. Non-volatile cache logical volume 1 426 is created for virtual machine 0 404. For example, logical volume store 430 and two logical volumes (non-volatile cache logical volume 0 424 and non-volatile cache logical volume 1 426) can be created for non-volatile cache 434 with 100 Giga Bytes (GiB) non-volatile cache 434. The size of each non-volatile cache logical volume 424, 426 is 100 GiB, to provide 200 GiB of logical memory and 100 Giga Bytes (GiB) physical memory (non-volatile cache 434). In the example shown in FIG. 4 there are 2 flash translation layers (flash translation layer 0 410 and flash translation layer 1 412). In other embodiments there can be more than 2 flash translation layers.

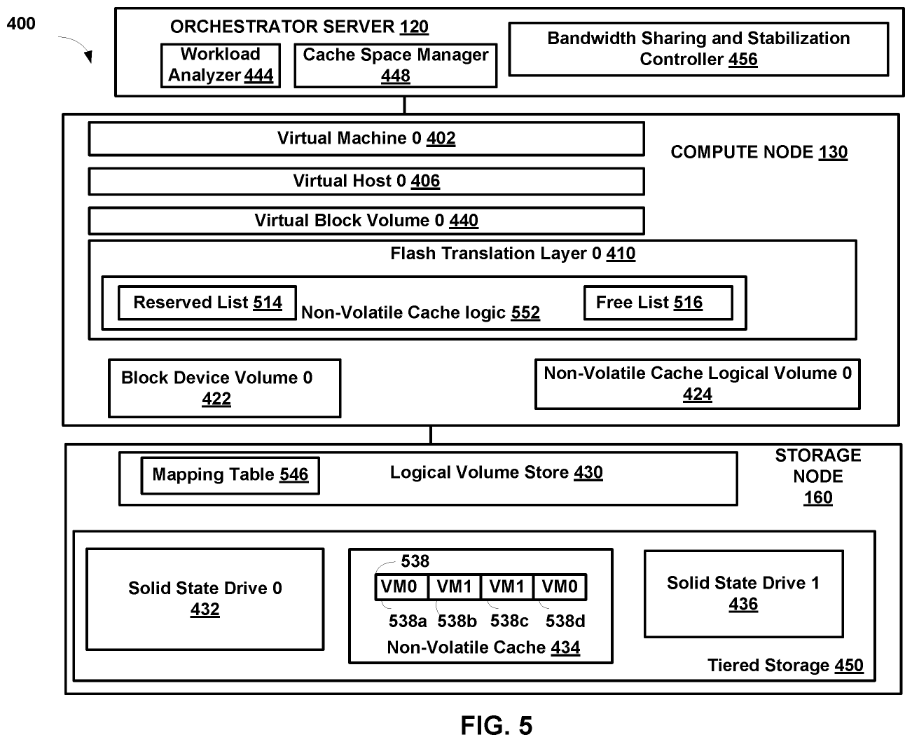

FIG. 5 is a block diagram of the system 400 shown in FIG. 4 with virtual machine 0 402 and flash translation layer 0 410 shown in FIG. 4 to dynamically assign non-volatile cache 434 in the storage node 160 for use by workloads in the compute node 130.

The cache space manager 448 in the orchestrator server 120 controls the allocation of clusters in non-volatile cache 434 to logical blocks, to avoid allocating more than the available physical memory to logical blocks, by managing the logical cache occupancy in flash translation layer 0 410. The cache space manager 448 also resizes the physical memory in non-volatile cache 434 allocated to virtual machine 0 402.

The flash translation layer 0 410 includes non-volatile cache logic 552. The non-volatile cache logic 552 splits the non-volatile cache 434 into chunks 538. In the example shown in FIG. 5, chunk 538a and chunk 538d are allocated to virtual machine 0 402 (VM0) and chunk 538b and 538c are allocated to virtual machine 1 402 (VM1). The non-volatile cache logic 552 manages a free list 516 of chunks and a reserved list 514 of chunks that are used to manage the chunks 538 in the non-volatile cache 434. During initialization of the non-volatile cache 434, chunks are initialized and the number of chunks in the non-volatile cache 434 that can be used (that is the number in the free list 516 of chunks) based on a cache size parameter that is set when the flash translation layer 0 410 is created. Chunks that can be used are in the free list 516. Chunks that cannot be used (assigned “reserved state”) are in the reserved list 514. Chunks in the reserved list are not used by the virtual machines 402, 404 and the logical space mapped to the chunk is not occupied.

For example, with the non-volatile cache 434 having 100 GiB, a chunk size of 1 GiB, and a cache occupancy parameter set to 50 GiB, 50 chunks are put on the free list 516 and 50 chunks are put on the reserved list 516. Only chunks that are on the free list 516 are assigned to workloads, so no more than 50 chunks of the non-volatile cache 434 are used

The logical volume store 430 creates a list of free clusters for the clusters in the non-volatile cache 434. In an embodiment in which the capacity of the non-volatile cache is 100 GiB and each cluster is 1 GiB contiguous space, there are 100 clusters in the non-volatile cache 434. The logical volume store 430 manages logical mapping from a non-volatile cache logical volume 424 to a physical cluster in granularity of 1 GiB. The logical mapping can be stored in a mapping table 546 in the logical volume store 430. In response to a request to access a logical block address in non-volatile cache 434 received from the non-volatile cache logical volume 0 424, the logical volume store 430 checks if there is an entry for the logical block address in the mapping table 546. If an entry for the logical block address is not in the mapping table 546, the logical volume store 430 allocates a free cluster from the list of free clusters (free list 516) to the logical block address and updates the mapping table 546.

The non-volatile cache 434 is organized in clusters that are allocated to logical blocks. The mapping of clusters allocated to logical blocks can be stored in the mapping table 546. The non-volatile cache 434 is organized in chunks (for example, 1 GiB chunks). In one embodiment, in the non-volatile cache logical volume 0 424, a chunk is the same size as a cluster and each cluster is 1 GiB. In another embodiment, the size of a cluster can be less than the size of a chunk in the non-volatile cache 434, for example, a cluster can be 100 MiB and a 1 GiB chunk in the non-volatile cache 434 includes 10 100 MiB clusters

The logical volume store 430 allocates physical memory blocks in the non-volatile cache 434 for flash translation layer 0 410. For example, a 100 GigaBytes (GiB) non-volatile cache physical memory can be split onto 100 clusters, with each cluster having 1 GiB and each cluster mapped to 1 GiB of contiguous physical blocks in the non-volatile cache 434.

The workload analyzer 444 in the orchestrator server 120 monitors workload. If the workload analyzer 444 determines that the workload is random, the workload analyzer 444 requests a reduction of the portion of the non-volatile cache 434 assigned for the workload. If the workload analyzer 444 determines that the workload is a locality (local) workload and free space is available, the workload analyzer 444 requests an increase of the portion of the non-volatile cache 434 assigned for the workload.

The cache space manager 448 monitors free chunks in the non-volatile cache 434 that are available for use by virtual machine 0 402 and manages requests to increase and reduce the number of free chunks in the non-volatile cache 434.

In response to a request to increase the number of free chunks in the non-volatile cache 434 received by the cache space manager 448, the cache space manager 448 checks if there is free space in the non-volatile cache 434. If there is free space in the non-volatile cache 434, the cache space manager 448 sends a request to flash translation layer 0 410 to increase the number of chunks in the free list 516. Flash translation layer 0 410 can use chunks in the reserved list 514 in the non-volatile cache 434. Flash translation layer 0 410 moves chunks from the reserved list 514 to the free list 516. During a first access in the non-volatile cache 434 to the chunk moved from the reserved list 514 to the free list 516, the logical volume store 430 allocates the respective cluster(s) for the chunk.

In response to a request received by the cache space manager 448 to decrease the number of free chunks in the non-volatile cache 434, the cache space manager 448 sends a request to flash translation layer 0 410 to reduce the number of chunks on the free list 516. The reduction in the number of free chunks in the non-volatile cache 434 is performed by flash translation layer 0 410 as a background task. When there are sufficient chunks in the free list 516, flash translation layer 0 410 sends an unmap request (for example, API cluster-align_unmap( ) to non-volatile cache logical volume 0 424 and the logical volume store 430. In response to a request to deallocate (for example, API deallocate_cluster( ) the corresponding clusters, the logical volume store 430 deallocates the corresponding clusters for the chunks moved to the reserved list 514 from the free list 516.

To reduce the portion of the non-volatile cache 434 assigned to the workload in the non-volatile cache 434, the cache space manager 448 sends a request to flash translation layer 0 410 to reduce the number of chunks assigned to the workload in the non-volatile cache 434. The number of writes to the non-volatile cache 434 are reduced in order to increase the number of available free chunks. When the number of free chunks in the free list 516 is sufficient, the free chunks are moved from the free list 516 to the reserved list 514. To move the chunk from the free list 516 to the reserved list 514, an unmap request is sent to the logical volume store 430, to release the mapping for the non-volatile cache logical volume 0 424. The mapping can be released by clearing the entry in the mapping table 546 for the mapping of the logical cluster to the physical cluster.

The cache space manager 448 monitors the non-volatile cache space assigned to flash translation layer 0 410 in the non-volatile cache 434. When there is sufficient free space in the non-volatile cache 434, and flash translation layer 0 410 requires additional non-volatile cache space, a resize request is sent to flash translation layer 0 410. The resize request can be sent via a Remote Procedure call (RPC) to flash translation layer 0 410. In response to the resize request, the requested number of chunks are moved from the reserved list 514 to the free list 516. As part of the chunk move operation, the non-volatile cache logic 552 in flash translation layer 0 410 issues a write to the chunk, to allocate it for a given cluster.

The bandwidth sharing and stabilization controller 456 in the orchestrator server 120 throttles writes from virtual machine 0 402 to retrieve free space assigned to a workload and allocates bandwidth of the non-volatile cache 434 to flash translation layer 0 410 to ensure that workloads receive sufficient bandwidth of the non-volatile cache 434.

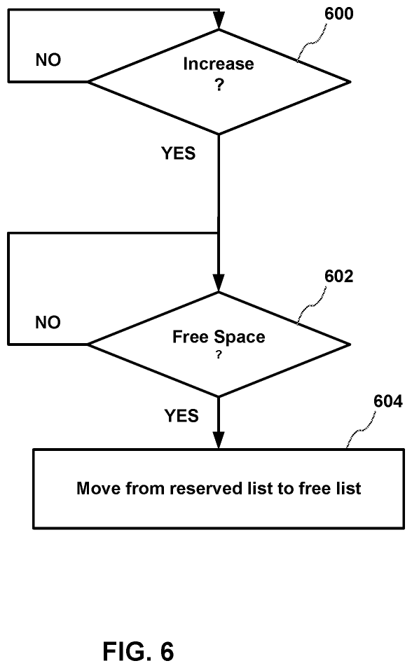

FIG. 6 is a flowgraph illustrating a method to increase the number of free chunks in the non-volatile cache 434.

At block 600, if the cache space manager 448 receives a request to increase the number of free chunks in the non-volatile cache 434, processing continues with block 602.

At block 602, the cache space manager 448 checks if there is free space in the non-volatile cache 434. If there is free space in the non-volatile cache 434, processing continues with block 604.

At block 604, the cache space manager 448 sends a request to flash translation layer 0 410 to increase the number of chunks in the free list 516. Flash translation layer 0 410 moves chunks from the reserved list 514 to the free list 516.

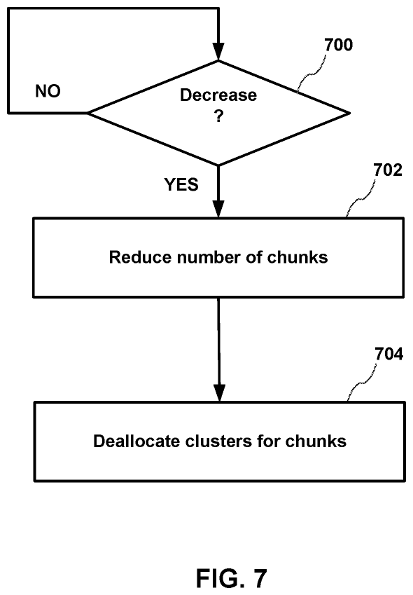

FIG. 7 is a flowgraph illustrating a method to decrease the number of free chunks in the non-volatile cache 434;

At block 700, if the cache space manager 448 receives a request to decrease the number of free chunks in the non-volatile cache 434, processing continues with block 702.

At block 702, the cache space manager 448 sends a request to the flash translation layer 410 to reduce the number of chunks on the free list 516. Processing continues with block 704.

At block 704, when the number of free chunks in the free list 516 is sufficient, the free chunks are moved from the free list 516 to the reserved list 514.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A non-transitory machine-readable storage medium can cause a machine to perform the functions or operations described, and includes any mechanism that stores information in a form accessible by a machine (for example, computing device, electronic system, etc.), such as recordable/non-recordable media (for example, read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASIC s), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. An apparatus comprising:
an orchestrator, the orchestrator to identify a workload type for a workload and to dynamically assign a portion of a non-volatile cache in a tiered storage for use by the workload based on the workload type, the tiered storage including the non-volatile cache and a storage device, the non-volatile cache to cache data for the workload to be written to the storage device.

2. The apparatus of claim 1, wherein the workload type is sequential, the orchestrator to request a reduction in the portion of the non-volatile cache assigned for the workload.

3. The apparatus of claim 1, wherein the workload type is random, the orchestrator to request a reduction in the portion of the non-volatile cache assigned for the workload.

4. The apparatus of claim 1, wherein the workload type is local, the orchestrator to request an increase of the portion of the non-volatile cache assigned for the workload.

5. The apparatus of claim 1, wherein the non-volatile cache is a byte-addressable, write-in-place non-volatile memory and the storage device is a solid state drive comprising a block addressable memory device.

6. The apparatus of claim 1, wherein the non-volatile cache is a solid state drive with byte-addressable, write-in-place non-volatile memory and the storage device is a second solid state drive comprising a block addressable memory device.

7. One or more non-transitory machine-readable storage media comprising a plurality of instructions stored thereon that, when executed by a compute device cause the compute device to:
cache data for a workload to be written to a non-volatile cache in a tiered storage, the tiered storage including the non-volatile cache and a storage device;
identify a workload type for the workload; and
dynamically assign a portion of the non-volatile cache for use by the workload based on the workload type.

8. The one or more non-transitory machine-readable storage media of claim 7, wherein the workload type is sequential, the compute device to request a reduction in the portion of the non-volatile cache assigned for the workload.

9. The one or more non-transitory machine-readable storage media of claim 7, wherein the workload type is random, the compute device to request a reduction in the portion of the non-volatile cache assigned for the workload.

10. The one or more non-transitory machine-readable storage media of claim 7, wherein the workload type is local, the compute device to request an increase of the portion of the non-volatile cache assigned for the workload.

11. The one or more non-transitory machine-readable storage media of claim 7, wherein the non-volatile cache is a byte-addressable, write-in-place non-volatile memory and the storage device is a solid state drive comprising a block addressable memory device.

12. The one or more non-transitory machine-readable storage media of claim 7, wherein the non-volatile cache is a solid state drive with byte-addressable, write-in-place non-volatile memory and the storage device is a second solid state drive comprising a block addressable memory device.

13. A system comprising:
a compute node, the compute node comprising a processor; and
an orchestrator, the orchestrator to identify a workload type for a workload and to dynamically assign a portion of a non-volatile cache in a tiered storage for use by the workload in the compute node based on the workload type, the tiered storage including the non-volatile cache and a storage device, the non-volatile cache to cache data for the workload to be written to the storage device.

14. The system of claim 13, wherein the workload type is sequential, the orchestrator to request a reduction in the portion of the non-volatile cache assigned for the workload.

15. The system of claim 13, wherein the workload type is random, the orchestrator to request a reduction in the portion of the non-volatile cache assigned for the workload.

16. The system of claim 13, wherein the workload type is local, the orchestrator to request an increase of the portion of the non-volatile cache assigned for the workload.

17. The system of claim 13, wherein the non-volatile cache is a byte-addressable, write-in-place non-volatile memory and the storage device is a solid state drive comprising a block addressable memory device.

18. The system of claim 13, wherein the non-volatile cache is a solid state drive with byte-addressable, write-in-place non-volatile memory and the storage device is a second solid state drive comprising a block addressable memory device.
